(19) United States
(12) Patent Application Publication
(10) Pub. No.: US 2007/0247402 A1
(43) Pub. Date: Oct. 25, 2007

(54) Method and a system for displaying a digital image in true colors

(76) Inventor: Jacques Delacour, Le Pradet (FR)

Correspondence Address: CLARK & BRODY, 1090 VERMONT AVENUE, NW, SUITE 250, WASHINGTON, DC, 20005, US

(21) Appl. No.: 11/712,477

(22) Filed: Mar. 1, 2007

Related U.S. Application Data
(63) Continuation of application No. PCT/FR05/02151, filed on Aug. 26, 2005.

(30) Foreign Application Priority Data
Sep. 2, 2005 (FR) 04 09306

(51) Int. Cl. G09G 3/36

(52) U.S. Cl. 345/87

(57) ABSTRACT

This method of displaying a digital image includes a step of obtaining a radiometric spectrum for each pixel of the image and over the entire visible light spectrum. For each of the pixels, and for at least four primary colors, the method comprises the steps of: calculating a luminance level directly from the radiometric spectrum, without carrying out an intermediate step of representing the image on the basis of three primary colors; deducing therefrom the value of a driver signal; and applying the driver signal associated with the primary color to a display device adapted to reproduce each of the primary colors.

The present invention relates to a method and a system for displaying a digital image in true colors.

### BACKGROUND OF THE INVENTION

In this specification, the term “digital image in true colors” is used to designate an image for which the radiometric spectrum is available for each pixel over the entire visible light spectrum.

Such an image may be obtained in particular using the light simulation SPEOS software that enables the brightness or luminance of a scene to be simulated.

That software, developed and sold by OPTIS, is briefly described, for example, in the journal “CAD Magazine” published in March 2004.

For more details, the person skilled in the art can refer to software user's guide: “User's Guide—Speos 2004 SP1-V.01-Copyright 2004”.

The invention seeks in particular to improve presently-known methods and systems for displaying images that rely, both in television and in computing, on using three primary colors: red, green, and blue.

FIG. 1 is a projection of the three primary colors into the visible color space in accordance with the state of the art as outlined briefly above.

The representation of the color space corresponds to the CIE 1934 colorimetry standard known to the person skilled in the art.

This figure comprises a curve known as the spectrum locus that is closed by a straight line segment, and that defines the visible color space E.

Each of the points on the curve corresponds to a monochromatic signal over the range [380 nanometers (nm), 780 nm]. The straight line segment closing the curve represents purple colors.

This figure also has three points R, G, and B representing respectively the primary colors red, green, and blue in the visible color space E of a conventional system for displaying a color image, here a tri-LCD video projector.

Those three points R, G, and B that depend on the display system define a space T of colors that can be displayed using those three primary colors.

It can clearly be seen in the figure that space T is considerably smaller than the visible color space E. This is particularly true for tri-LCD video projectors in which the display primary colors are not very saturated.

The historical choice to use three primary colors, although it enables a wide range of colors to be displayed, nevertheless restricts the space of colors that can be displayed, compared with the space of all visible colors. This is particularly harmful when it is desired to display an image for which, for each pixel, the radiometric spectrum is available over the entire visible light spectrum.

It should be observed that display systems also exist for displaying an image represented by three original primary colors but using, for display purposes, a number of primary colors that is greater than three, e.g. four, or six.

In such display systems, and in particular as disclosed in document U.S. Pat. No. 6,570,584, for each pixel of an image, a component associated with each of the additional display primary colors is extrapolated from the original three components. That makes it possible artificially to increase the displayable color space, but results in a departure from the true color space.

In particular, document US 2004/046939 describes a system for displaying an image represented on three original primary colors, the system being made up of two projectors with their projections being superposed. That system possesses three inputs, for each of the three original primary colors, respectively. The system described serves by extrapolation from the three original primary colors to calculate new colors, e.g. three new colors, that can be displayed by one of the two projectors.

Thus, the display quality of the image obtained by such a system is limited by the initial representation of the image in three original primary colors, even if the system is adapted to derive other colors therefrom.

The person skilled in the art will understand that the colors displayed by the system proposed in document US 2004/0469393, outside the space T, are colors that have been obtained by extrapolation.

### OBJECTS AND SUMMARY OF THE INVENTION

The invention seeks to mitigate those drawbacks by proposing a method and a system for displaying an image that complies with the true colors of the image and that does not make use of any extrapolation.

To this end, the invention provides a display method for displaying a digital image, the method comprising a step of obtaining a radiometric spectrum for each pixel of the image over the entire visible spectrum.

Then, for each of the pixels, and for at least four primary colors, the method comprises the following steps:
calculating a luminance level directly from said radiometric spectrum without carrying out an intermediate step of representing the image on the basis of three primary colors;
deducing therefrom the value of a driver signal; and
applying said driver signal associated with said primary color to a display device adapted to reproduce each of said primary colors.

Prior art display with at least four primary colors consists in carrying out an intermediate representation using three standardized red, green, and blue components, commonly referred to as X, Y, and Z in the literature.

Then, the levels for each primary colors are calculated from those three intermediate components X, Y, and Z, using a method involving the color space and not the physical spectrum of light.

Advantageously, the display method of the invention calculates luminance levels associated with each primary directly from the radiometric spectrum, without carrying out an intermediate step of representing the image on the basis of three primary colors: red, green, and blue.

The display is thus provided on at least four primary colors, without loss of information. This considerably increases the number of colors that can be displayed compared with conventional RGB display methods.

The invention thus improves existing display methods by avoiding an intermediate representation, generally based on three primary colors, which causes spectral information to be lost.

Preferably, the display method of the invention further comprises, for each of said primary colors, a prior step of calculating a calibration coefficient on the basis of measuring the light flux for said primary color as reproduced by the display device, said calibration coefficient being taken into account when calculating the driver signal.

This weighting of the components of each primary color makes it possible to guarantee that displaying a white spectrum gives a spectrum that is accurately white.

In a particular implementation, in which six primary colors are used, the method of the invention further comprises a prior step of selecting the six primary colors, by performing the following substeps:
subdividing a continuous white spectrum into six contiguous spectral bands;
associating each of the bands with a point in the color space of position that depends on the wavelength of the center wavelength of the band; and
adjusting the points in such a manner as to optimize the area of the hexagon interconnecting the six points relative to the set of visible colors.

This step of selecting six primary colors thus makes it possible to maximize the number of colors that can be displayed and thus to maximize the color space that is displayable by the method of the invention.

Preferably, the above-mentioned adjustment of the bandwidths is performed in such a manner as to obtain visual luminance levels that are substantially equivalent for each of the bands.

This characteristic makes it possible, advantageously, to use the same quantity of light for displaying each primary color, thus making it possible to avoid any need to increase or decrease the intensity of a primary color in exaggerated manner, thereby serving to maximize the dynamic range of the display.

In a preferred embodiment, a display device is used that is constituted by two video projectors whose respective images are superposed. The video projectors are standard video projectors in which the dichroic filters have been replaced by specific filters adapted to faithfully reproduce the above-mentioned six primary colors, each video projector reproducing three of the six primary colors.

This embodiment does make it possible to make up a true color display device by using traditional video projectors based on the three red, green, and blue primaries, and in which only the color filters are modified.

Preferably, the two video projectors are connected to respective video outputs of a single graphics card of the “Dual Screen” type installed in a computer, such as for example the Wildcat 7210 card from the supplier 3Dlabs or the QuadroFX 500 card from the supplier NVidia.

In another embodiment, two graphics cards are installed in a computer, a first video projector being connected to the video output of a first graphics card, and a second video projector being connected to the video output of a second graphics card.

The cards are synchronized so as to enable the respective images from the two projectors to be superposed.

In this embodiment, it is advantageous to use a graphics card designed for a different use, thus making it possible to embody a true color display device in very simple manner.

The invention also provides a display system for displaying a digital image, the system comprising:
a device for generating a computer file comprising data representative of a radiometric spectrum for each of the pixels of the image, and over the entire visible light spectrum;
calculation means suitable for calculating, from the file, for each of the pixels and for at least four primary colors:
   a luminance level directly from the radiometric spectrum without carrying out an intermediate step of representing the image on the basis of three primary colors; and
   a driver signal associated with the primary color as a function of the luminance; and
a display device connected to the calculation means and having at least one input associated with each of said primary colors.

Since the particular advantages of the display system are the same as those of the above-described method, they are not recalled below.

### BRIEF DESCRIPTION OF THE DRAWINGS

Other aspects and advantages of the present invention appear more clearly on reading the following description of particular embodiments, the description being given purely by way of non-limiting example and making reference to the accompanying drawings, in which:

FIG. 1, described above, shows the projection of three primary colors in the visible color space, in accordance with the state of the art;

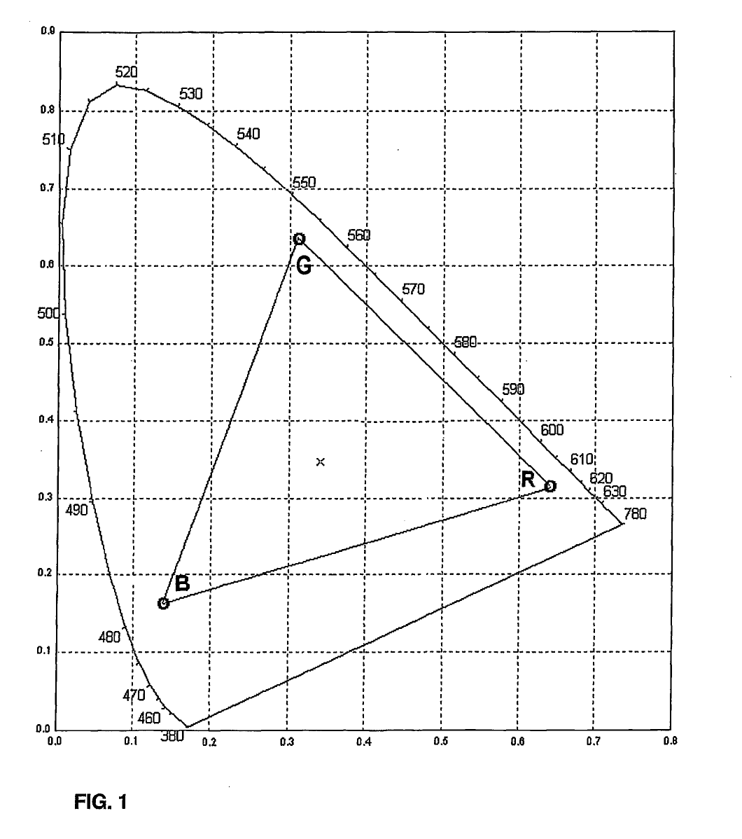

FIG. 2 shows the main steps of a display method of the invention, in a preferred implementation;

FIG. 3 is a diagram showing how a continuous white spectrum is subdivided in accordance with an implementation of the invention;

FIG. 4 shows the projection of six primary colors in the visible color space in accordance with the invention, in a preferred implementation;

FIG. 5 shows a projection system in accordance with the invention in a preferred embodiment; and

FIGS. 6a and 6a show respectively the use of a “Dual Screen” type card in accordance with the prior art and in accordance with the invention.

### MORE DETAILED DESCRIPTION

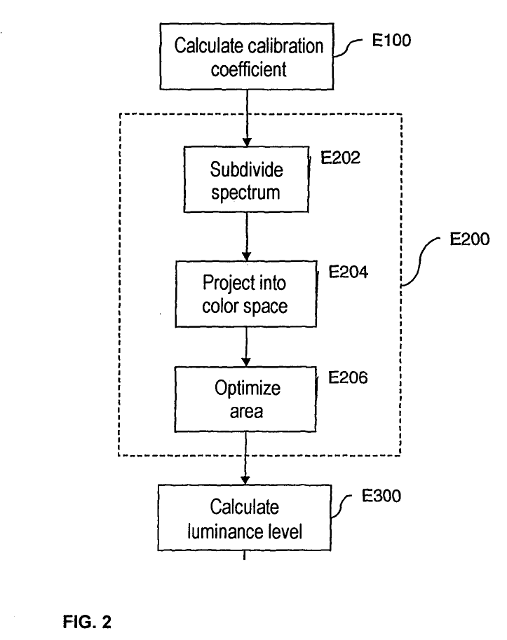

FIG. 2 shows the main steps in a display method of the invention, in a preferred implementation.

By way of example, there follows a detailed description of displaying a file XMP generated by the above-mentioned SPEOS software, the file comprising the radiometric spectrum in the visible range for each pixel of an image.

More precisely, the file XMP comprises, for each pixel pix, the radiance S(pix, λᵢ) for each wavelength λᵢ taken in a range [λ_{MIN}, λ_{MAX}] with a sampling interval λ_{N}.

In a first implementation, the values λ_{MIN}, λ_{MAX}, and λ_{N} are respectively equal to: 360 nm, 830 nm, and 1.

During a first step E200, comprising three sub-steps E202, E204 and E206, six primary colors are selected.

During the first sub-step E202, a continuous white spectrum, i.e. extending from 400 nm to 700 nm, is subdivided into six contiguous spectral bands respectively labeled blue (BL), cyan (CY), deep green (DG), cabbage green (CG), yellow (YE), and red (RE).

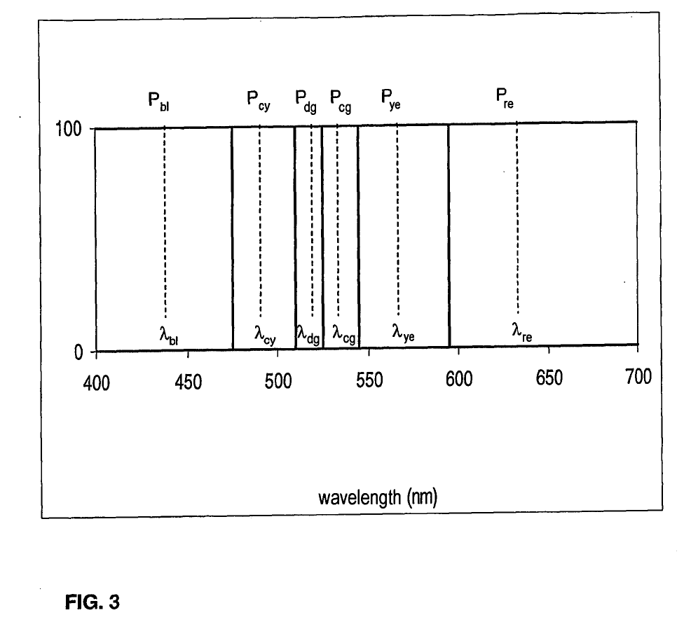

This subdivision is shown diagrammatically in FIG. 3. This figure also shows the six center wavelengths of these bands that are respectively labeled: λ_{BL}, λ_{CY}, λ_{DG}, λ_{CG}, λ_{YE}, and λ_{RE}. In reality, and because of the technology used, the bands are not exactly contiguous and they are not exactly of squarewave shape.

The six colors associated with these six center wavelengths are referred to below as being “primary” colors and they likewise labeled blue (BL), cyan (CY), deep green (DG), cabbage green (CG), yellow (YE), and red (RE) for simplification purposes.

The subdivision sub-step E202 is followed by a second sub-step E204 during which six points P_{BL}, P_{CY}, P_{DG}, P_{CG}, P_{YE}, and P_{RE}, are projected into the visible color space in positions that depend on the above-mentioned six center wavelengths λ_{BL}, λ_{CY}, λ_{DG}, λ_{CG}, λ_{YE}, and λ_{RE}.

These six points define a hexagon H that is used in the remainder of the method.

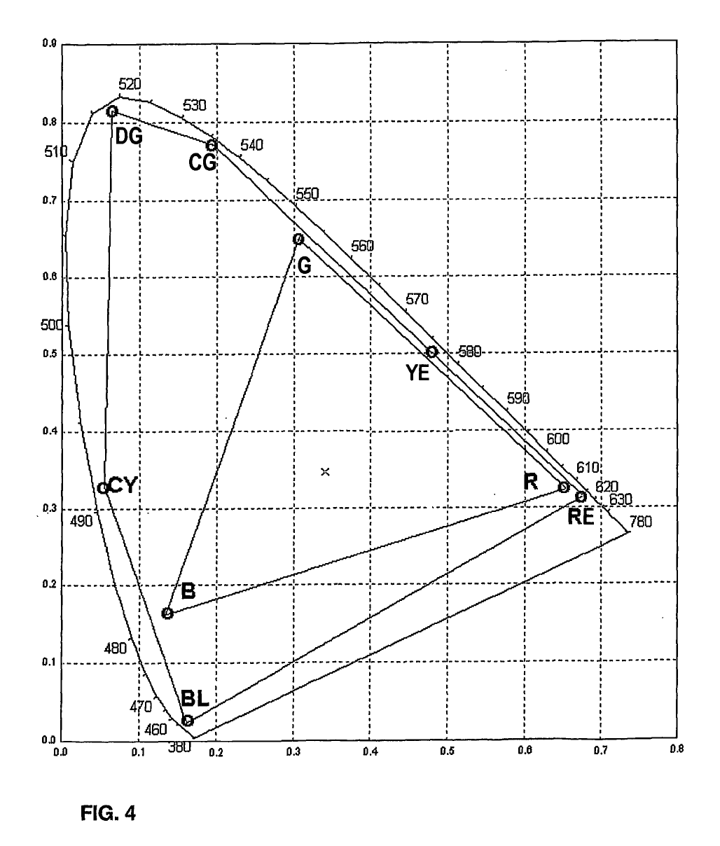

This projection is shown diagrammatically in FIG. 4.

The projection sub-step E204 is followed by a sub-step E206 during which the set of colors. displayable by the display method of the invention is maximized.

This step consists in causing the positions of the six points P_{BL}, P_{CY}, P_{DG}, P_{CG}, P_{YE}, and P_{RE} to vary so as to maximize the area of the above-mentioned hexagon H.

In the preferred implementation described herein, this optimization step E206 consists in approximating the edge of the visible color space by six straight line segments. These straight line segments are disposed so as to approach as close as possible to the edge of the visible color space (a technique known as meshing).

The vertices of the segments then define the center wavelengths. The subdivision into spectral bands is then performed so as to center each band on each center wavelength as defined in this way. Then the width of each spectral band is adjusted so that the relative visual powers (proportional to lumens) contained in each spectral band are equivalent.

Naturally, other methods could be used for maximizing the area of the hexagon H, such as for example the method of numerical calculation of weighted least squares.

This maximization sub-step E206 terminates the step E200 of selecting six primary colors.

The display method of the invention uses a display device adapted to reproduce the six primary colors. Below, the term “R_{LAMP}” is used to designate the absolute emission spectrum of the light sources of the display device.

In the preferred embodiment of the invention as described herein, the display device has six dichroic filters F_{BL}, F_{CY}, F_{DG}, F_{CG}, F_{YE}, and F_{RE}, each of them being designed to reproduce one of the above-specified six primary colors BL, CY, DG, CG, YE, and RE.

In a preferred variant embodiment, the step E200 of selecting six primary colors is followed by a step E100 of calculating calibration coefficient γ_{BL}, γ_{CY}, γ_{DG}, γ_{CG}, γ_{YE}, and γ_{RE} associated with each primary color.

The calibration coefficients enable the white balance to be adjusted, i.e. they serve to guarantee that the display of a white spectrum gives a spectrum that is white. These coefficients are calculated once only during factory adjustment of the device.

The calibration coefficient γ_{BL} associated with the “blue” primary color is preferably obtained as follows, with the other coefficients being obtained in identical manner:

The display device displays the blue primary at maximum level. The luminance of the blue is then measured using a photometric camera or with the help of any other device for measuring luminance. Thereafter, the theoretical luminance for blue (ideally obtained when the primaries of the display device have the same luminance) is calculated using spectral data for the blue primary color. The calibration coefficient γ_{BL} is then obtained by calculating the ratio between the measured luminance and the calculated theoretical luminance.

In the preferred implementation described herein, the step E200 of calculating the calibration coefficients is followed by a step E300 of calculating a luminance level for each pixel of the image represented by the file XMP, and for each of the primary colors BL, CY, DG, CG, YE, and RE. This calculation is performed prior to each display of an image by the device.

Using as an example the blue primary colors “BL”, the luminance level N(pix, BL) of the pixel pix is obtained by calculating the fraction of the energy of the initial radiometric spectrum that corresponds to the spectrum of the blue primary. This calculation, well known to the person skilled in the art, corresponds to a projection and involves integral calculus.

The step E300 of calculating the luminance levels is followed by a step E400 during which, for each primary colors, e.g. BL, a value is calculated for a driver signal V_{BL} as a function of the luminance level N(pix, BL).

In this preferred implementation as described herein, this produces six driver signals V_{BL}, V_{CY}, V_{DG}, V_{CG}, V_{YE}, and V_{RE}, for each component BL, CY, DG, CG, YE, and RE of the image. By way of example, these driver signals may be of the composite type, like those used by video monitors.

These six values for driver signals are then applied during a step E500 to the six inputs of the driver device of the invention for displaying the image, each input controlling the display of one given primary color.

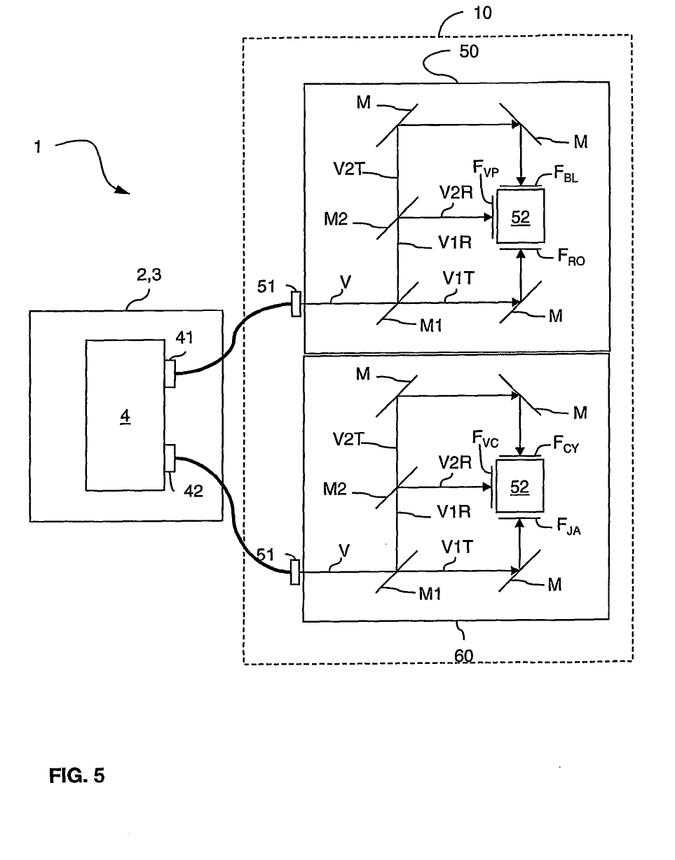

FIG. 5 shows a projection system 1 in accordance with the invention in a preferred embodiment.

In accordance with the present invention, the system 1 includes a device 2 for generating a computer file representative of an image.

In the embodiment described herein, this file comprises, for each pixel of the image, luminance data and spectrum distribution data.

In the preferred embodiment, the generator device 2 is constituted by a personal computer 3 implementing the above-mentioned SPEOS image generation software.

Advantageously, such image synthesis software, based entirely on optics and physics, makes use of the entire visible light spectrum, without restriction on color information. This software makes it possible to generate synthesized images implementing a spectral algorithm.

In the preferred embodiment described herein, the display system 1 of the invention includes two video projectors 50 and 60.

These two video projectors differ from each other in the optical characteristics of their dichroic filters. These dichroic filters are adapted to reproducing the primary colors BL, CY, DG, CG, YE, and RE.

The first video projector 50 has an input 51 for three of the six driver signals V_{BL}, V_{DG}, and V_{RE}, and this input may, for example, be a VGA input of the kind used in video monitors.

The light beam for illuminating LCD matrices is separated into three primary components BL, DG and RE as described below.

The first video projector 50 has a first dichroic mirror M1 placed at 45 degrees to the propagation axis of the illuminating light beam, operating in the spectral range [390 nm, 710 nm] as a highpass filter with a cutoff wavelength of 545 nm. This filter acts as a mirror. It transmits light above 545 nm and it reflects light below 545 nm.

This first video projector 50 has a mirror M arranged parallel to the first dichroic mirror M1 and adapted to reflect the portion V1T of the illuminating light beam that has passed through the first dichroic mirror M1 toward the dichroic filter F_{RE}. The light passing through the filter F_{RE} has a spectrum extending from 545 nm to 710 nm. It is then filtered so as to pass only light that corresponds to the primary color RE.

The first video projector 50 has a second dichroic mirror M2 arranged parallel to the first dichroic mirror M1 and adapted to receive the portion V1R of the illuminating light beam that is reflected by the first dichroic mirror M1.

The second dichroic mirror M2 is placed at 45 degrees to the propagation axis of the signal V1R and operates in the spectral band [390 nm, 540 nm] as a lowpass filter with a cutoff wavelength of 510 nm. This filter acts as a mirror. It transmits light below 510 nm and it reflects light above 510 nm.

The second dichroic mirror M2 is adapted to reflect the portion V2R of the illumination light beam V1R that is reflected by the first dichroic mirror M1 towards the dichroic filter F_{DG}. The light passing through the filter F_{DG} has a spectrum extending from 510 nm to 545 nm. It is then filtered so as to pass only light corresponding to the primary color DG.

The first video projector 50 has two mirrors M adapted to reflect the portion V2T of the illumination light beam V1R that has passed through the second dichroic mirror M2 towards the dichroic filter F_{BL}. The light passing through the filter F_{BL} has a spectrum extending from 390 nm to 510 nm. It is then filtered so as to pass only light that corresponds to the primary color BL.

This operation thus gives three light beams with the respective spectra of these light beams being those of the blue, deep green, and red primary colors BL, DG, and RE.

In known manner, the first video projector 50 includes a tri-LCD cube for projecting the image, each LCD matrix being illuminated by one of the light beams obtained in this way.

The second video projector 60 is identical to the first video projector 50, except that the dichroic filters F_{RE}, F_{DG}, and F_{BL} are respectively replaced by dichroic filters F_{YE}, F_{CG}, and F_{CY}.

In a variant, highpass absorbent filters could be used instead of three of the six dichroic filters: F_{CY}, F_{CG}, and F_{RE}.

In a variant, the dichroic filters F_{BL}, F_{CY}, F_{DG}, F_{CG}, F_{YE}, and F_{RE}, could be distributed in some other manner between the two video projectors 50 and 60.

The display system 1 of the invention also has calculator means adapted to implement, for each pixel pix of the image represented by the file XMP generated by the SPEOS software, and for each of the six primary colors BL, . . . , RE, the steps E300 of calculating the luminance levels N(pix, BL), . . . , N(pix, RE), and E400 of calculating the driver signals V_{BL}, . . . , V_{RE}.

In the embodiment described herein, the means for implementing the step E300 of calculating light levels are constituted by the computer 3 in combination with the SPEOS software, which software is modified to enable six primary colors to be displayed via the video projectors 50 and 60. In its standard version, SPEOS projects the radiometric spectrum of the pixel using the three standardized components X, Y, and Z of radiometric standards. Thereafter, SPEOS transforms these three components X, Y, and Z into three components R, G, and B using a transformation matrix that involves the primary colors of the video monitor being used for display purposes. The three RBG components are then sent to the monitor.

In accordance with the invention, the radiometric spectrum of the pixel is projected directly onto the six spectra of the six primary colors. The six components obtained in this way are then weighted by the calibration coefficients and then sent to the two modified video projectors.

The conventional video display primary colors X, Y, and Z used by the software are thus replaced by the six primary colors BL, . . . , RE.

In the preferred embodiment described herein, the means for implementing the step E400 of calculating the driver signals are constituted by a graphics card 4 inserted in the computer 3 and by the driver software of the card 4.

More precisely, and most advantageously, the computer 3 is fitted with the Windows NT, 2000, or XP (registered trademark) operating system sold by the supplier Microsoft, and the graphics card 4 is of the “Dual Screen” type.

In particular, it is possible to use the card sold by the supplier 3Dlabs under the reference Wildcat 7210, or the card sold by the supplier NVidia under the reference QuadroFX 500.

Such a card has two screen outputs referenced 41 and 42 in FIG. 5.

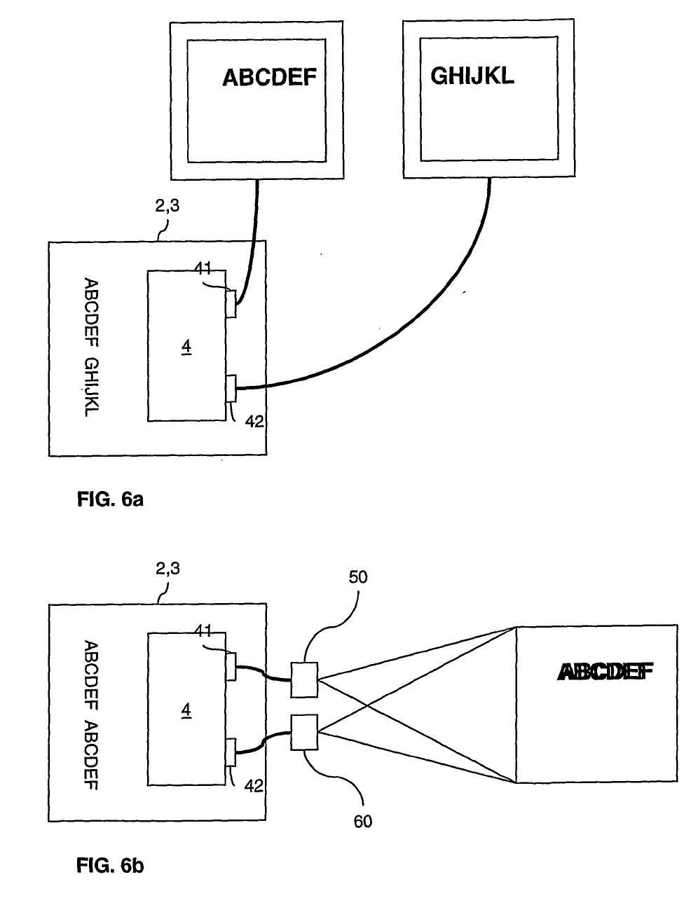

In known manner, such a card is traditionally used for displaying a Windows screen spread over two separate monitors, connected respectively to the screen outputs 41 and 42, in a configuration as shown in FIG. 6a.

The preferred embodiment of the invention described herein uses the graphics card 4 in particularly advantageous manner to implement the scheme shown in FIG. 6b.

This utilization consists:
in displaying a first image containing the coefficients of the primary colors BL, DG, and RE replacing the conventional coefficients RGB for the left-hand portion of the Windows screen;
in displaying a second image containing the coefficients of the primary colors CY, CG, and YE replacing the conventional coefficients RGB on the right-hand portion of the Windows screen;
in connecting the input 51 of the video projector 50 to the screen output 41 and the input 51 of the video projector 60 to the output 42; and
in superposing the two video projectors 50 and 60 in such a manner that the images are superposed.

This produces the display of the synthesized image represented in the file XMP in colors that are true and faithful to reality.

Another embodiment for displaying the synthesized image represented in the file XMP consists in using a plurality, in particular two, graphics cards each having a single output and each connected to one of the projectors. Each card possessing a screen output processes three of the colors. In particular, it is possible to use the card sold by the supplier ATI under the reference ATI RADEON 9800 or the card sold by the supplier MSI under the reference MSI RADEON RX600XT, or the card sold by the supplier NVidia under the reference XFX GeForce FX5200.

In known manner, such a card is traditionally used for displaying a Windows screen. The two cards are synchronized and used as follows:
the first card displays a first image containing the coefficients of the primary colors BL, DG, and RE replacing the conventional coefficients RGB on a first Windows screen;
the second card displays a second image containing the coefficients of the primary colors CY, CG, and YE replacing the conventional coefficients RGB on a second Windows screen;
the input of a first video projector is connected to the screen output of the first card and the input of a second video projector is connected to the screen output of the second card; and
the two video projectors are superposed so that the images are superposed.

The invention can be used in particular for displaying images with hyper-realistic rendering and without deteriorating the shades of color.

What is claimed is:

1. A display method for displaying a digital image, the method comprising a step of obtaining a radiometric spectrum for each pixel of the image over the entire visible spectrum, wherein for each of said pixels, and for at least four primary colors, the following steps are performed:
calculating a luminance level directly from said radiometric spectrum without carrying out an intermediate step of representing the image on the basis of three primary colors;
deducing therefrom the value of a driver signal; and
applying said driver signal associated with said primary color to a display device adapted to reproduce each of said primary colors.

2. A display method according to claim 1, further comprising, for each of said primary colors, a prior step of calculating a calibration coefficient from the measured light flux of said primary color reproduced by said display device, and wherein account is take of said calibration coefficient for calculating said driver signal.

3. A display method according to claim 1, in which six primary colors are used, the method further comprising a prior step of selecting said six primary colors, in which step the following substeps are performed:
subdividing a continuous white spectrum into six contiguous spectral bands;
associating each of said bands with a point in the color space of position that depends on the wavelength of the center wavelength of said band; and
adjusting said points in such a manner as to optimize the area of the hexagon interconnecting the six points relative to the set of visible colors.

4. A display method according to claim 3, wherein the widths of said bands are adjusted so as to obtain visual luminance levels that are substantially equivalent.

5. A display method according to claim 3, wherein said display device is constituted by two video projectors whose respective images are superposed.

6. A display method according to claim 5, wherein each video projector is connected to one of the video outputs of a single graphics card installed in a computer.

7. A display method according to claim 6, wherein said graphics card is of the “Dual Screen” type (registered trademark).

8. A display method according to claim 5, wherein, for a computer having two graphics cards installed therein, a first video projector is connected to the video output of a first graphics card, and a second video projector is connected to the video output of a second graphics card.

9. A display system for displaying a digital image, the system comprising:
a device for generating a computer file comprising data representative of a radiometric spectrum for each of the pixels of said image, and over the entire visible light spectrum;
calculation means suitable for calculating, from said file, for each of said pixels and for at least four primary colors:
a luminance level directly from said radiometric spectrum without carrying out an intermediate step of representing the image on the basis of three primary colors; and
a driver signal associated with said primary color as a function of said luminance; and
a display device connected to said calculation means and having at least one input associated with each of said primary colors.

10. A display system according to claim 8, wherein the display device is constituted by two video projectors having three primary colors each and with their respective images being superposed.

11. A display system according to claim 9, wherein each of said video projectors includes an appropriate set of optical filters, arranged in such a manner as to reproduce three of the six primary colors.

12. A display system according to claim 10, wherein each video projector is connected to one of the video outputs of a single graphics card of the “Dual Screen” type (registered trademark).

13. A display system according to claim 10, comprising two graphics cards, a first video projector being connected to the video output of a first graphics card, and a second video projector being connected to the video output of a second graphics card.
